(19) United States
(12) Patent Application Publication
(10) Pub. No.: US 2014/0043475 A1
(43) Pub. Date: Feb. 13, 2014

(54) MEDIA DISPLAY SYSTEM AND ADJUSTMENT METHOD FOR ADJUSTING ANGLE OF THE MEDIA DISPLAY SYSTEM

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(21) Appl. No.: 13/656,900

(22) Filed: Oct. 22, 2012

(30) Foreign Application Priority Data
Aug. 9, 2012 (TW) 101128850

(51) Int. Cl. H04N 7/18

(52) U.S. Cl. 348/143; 348/E07.085

(57) ABSTRACT

An adjustment method for a media display system includes capturing an image of a viewer, detecting a midline of a face region in the image, obtaining a midline of the image, comparing the midline of the face region with the midline of the image to determine whether the two midlines coincide with each other and outputting a comparison signal correspondingly, and driving a driving apparatus to adjust an angle of an electronic billboard according to the comparison signal.

### BACKGROUND

1. Technical Field

The present disclosure relates to a media display system and an adjustment method for adjusting an angle of the media display system.

2. Description of Related Art

Outdoor media, such as electronic billboards, provide advertising and information to the public. Most of these electronic billboards are mounted at a fixed angle. Viewing of the display may be uncomfortable or difficult for those whose line of sight is outside the intended viewing angle of the electronic billboard.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of an exemplary embodiment of a media display system.

FIG. 2 is a block diagram of the media display system, wherein the media display system includes a storage unit.

FIG. 3 is a block diagram of the storage unit of FIG. 2.

FIGS. 4-7 are schematic views showing adjusting the media display system of FIG. 1.

FIG. 8 is a flowchart of an exemplary embodiment of an adjustment method for a media display system, according to an embodiment.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

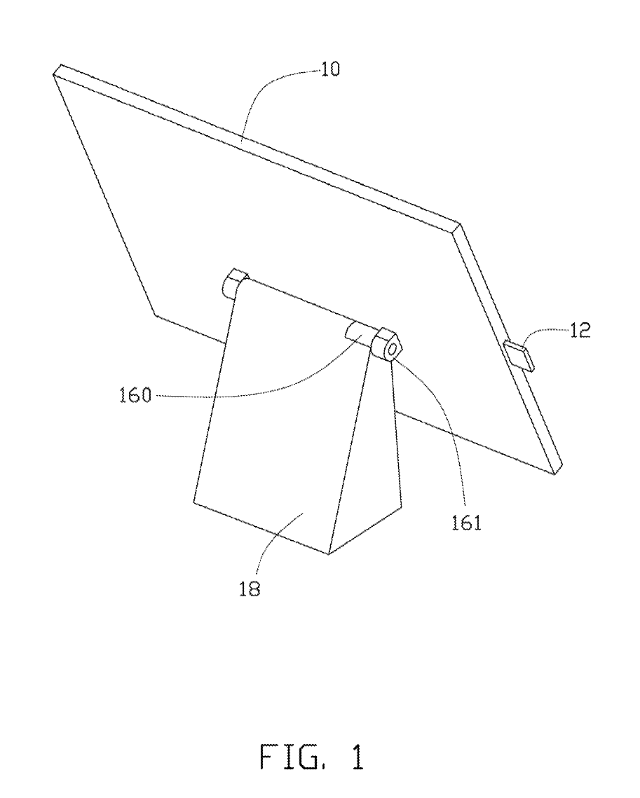

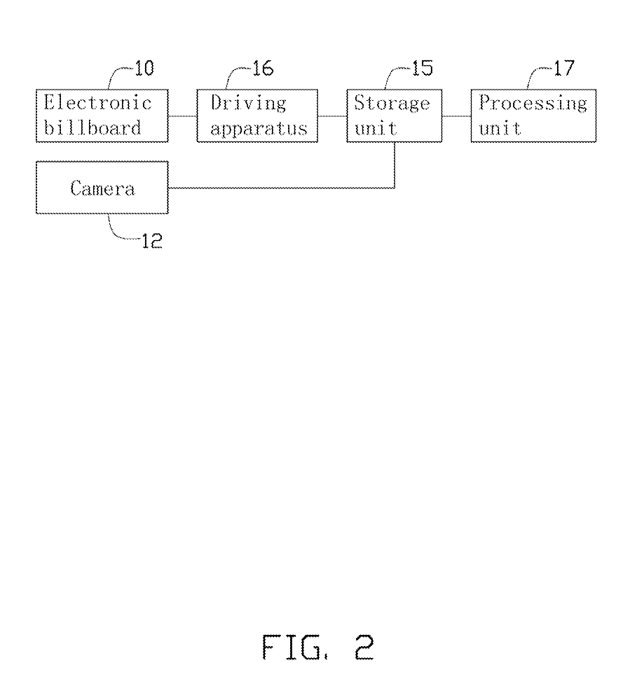

Referring to FIGS. 1 and 2, an exemplary embodiment of a media display system is shown. The media display system includes a bracket 18, an electronic billboard 10, a camera 12, a storage unit 15, a processing unit 17, and a driving apparatus 16. The media display system can adjust an angle of the electronic billboard 10 relative to the bracket 18.

The camera 12 is mounted on a left side or a right side of the horizontally extended midline (the midline) of the electronic billboard 10, to capture an image in front of the electronic billboard 10. The processing unit 17 and the storage unit 15 process the image captured by the camera 12. The processing unit 17 and the storage unit 15 further control the driving apparatus 16 to adjust the angle of the electronic billboard 10 according to the processing result of the processing unit 17 and the storage unit 15.

In detail, the processing unit 17 and the storage unit 15 process the image to determine whether there is a viewer in front of the electronic billboard 10. If there is a viewer in front of the electronic billboard 10, the processing unit 17 and the storage unit 15 further obtain a face region in the image, and adjust the electronic billboard 10 through the driving apparatus 16. The camera 12 captures another image in front of the electronic billboard 10. The above-mentioned process is executed, until a midline of the face region coincides with a midline of an image captured by the camera 12. The viewer then can comfortably view the electronic billboard 10. If there is more than one viewer in front of the electronic billboard 10, the processing unit 17 and the storage unit 15 further obtain more than one face region in the image, and obtain an average midline of midlines of the more than one face region. The processing unit 17 and the storage unit 15 then adjust the electronic billboard 10 through the driving apparatus 16, until the average midline of midlines of the more than one face region coincides with the midline of an image captured by the camera 12, such that the viewers can comfortably view the electronic billboard 10.

In the embodiment, the driving apparatus 16 includes two rotating blocks 161 mounted on a back of the electronic billboard 10, and a motor 160 mounted on a top of the bracket 18. An axis of the motor 160 is engaged in a fixing hole of one of the rotating block 161. When the motor 160 is operating, the electronic billboard 10 is rotated about the axis of the motor 160, such that an angle of the electronic billboard 10 can be adjusted.

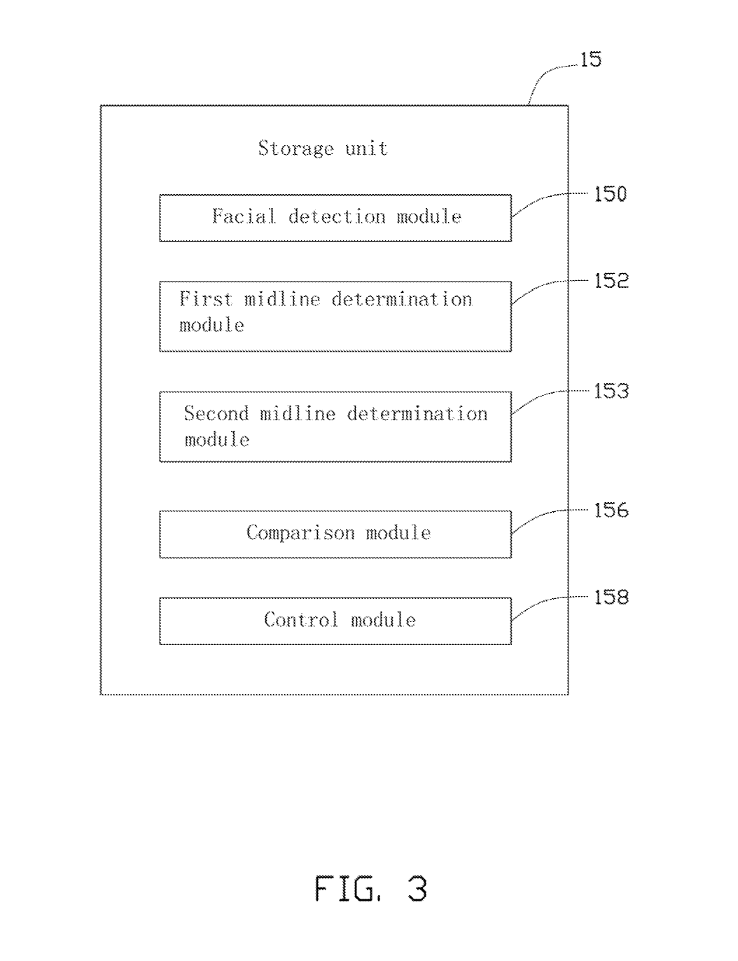

Referring to FIG. 3, the storage unit 15 includes a facial detection module 150, a first midline determination module 152, a second midline determination module 153, a comparison module 156, and a control module 158, which may include one or more computerized instructions executed by the processing unit 17.

The facial detection module 150 detects the face region in the image captured by the camera 12. The facial detection module 150 uses well known facial recognition technology to detect a face region in an image.

The first midline determination module 152 obtains a midline of the face region in the image. The second midline determination module 153 obtains a midline of the image. The comparison module 156 compares the midline of the face region and the midline of the image, and outputs a corresponding comparison signal to the control module 158. The control module 158 directs the driving apparatus 16 to adjust the angle of the electronic billboard 10 if the midline of the face region does not coincide with the midline of the image.

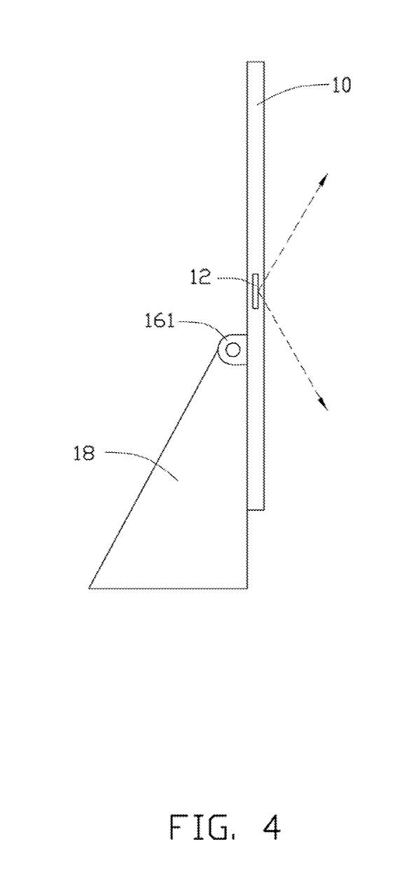

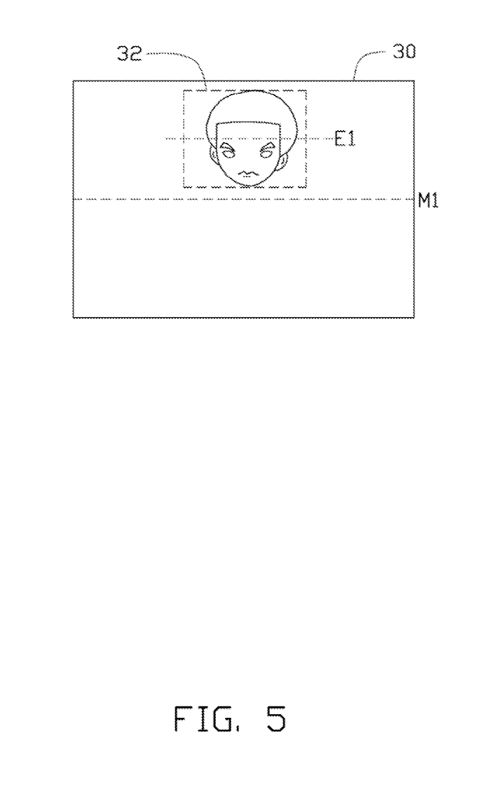

Referring to FIGS. 4 and 5, in use, the camera 12 captures an image 30 in front of the electronic billboard 10. In the embodiment, in the image 30, other portions, such as the shoulder and neck, are cropped.

The facial detection module 150 detects the face region 32 in the image 30. The first midline determination module 152 obtains the midline E1 of the face region 32 in the image 30. The second midline determination module 153 obtains the midline M1 of the image 30. The comparison module 156 compares the midline M1 of the image 30 with the midline E1 of the face region 32 to determine whether the midline E1 of the face region 32 coincides with the midline M1 of the image 30. The comparison module 156 outputs a corresponding comparison signal to the control module 158. The control module 158 directs the driving apparatus 16 to rotate clockwise for an angle, such as five degrees, if the midline E1 of the face region 32 is higher the midline M1 of the image 30.

Conversely, if the midline E1 of the face region 32 in the image 30 is lower than the midline M1 of the image 30, the control module 158 directs the driving apparatus 16 to rotate anti-clockwise for five degrees.

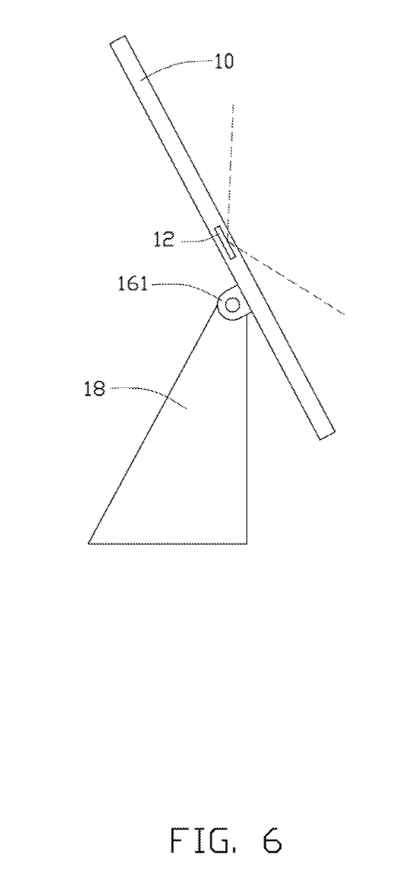

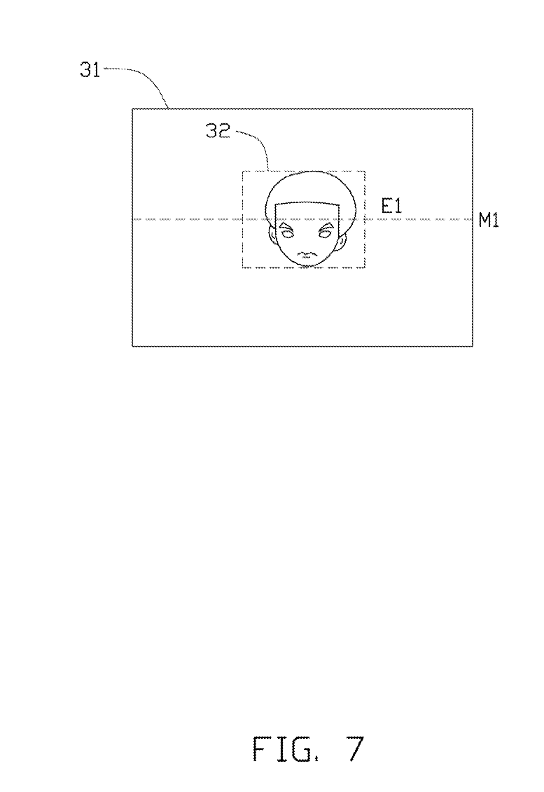

As shown in FIGS. 6 and 7, the camera 12 repeats capturing images, until the midline E1 of the face region 32 coincides with the midline of the last image 30 captured by the camera 12. The control module 158 stops directing the driving apparatus 16. The viewer can comfortably view the electronic billboard 10.

In the embodiment described above, there is only one viewer. In other embodiments, if there is more than one viewer, the facial detection module 150 detects the image captured by the camera 12 to locate a plurality of face regions in the image. The first midline determination module 152 detects the face regions to locate midlines in the face regions, and obtains an average midline of the midlines. The comparison module 156 compares the average midline with the midline M1 of the image 30.

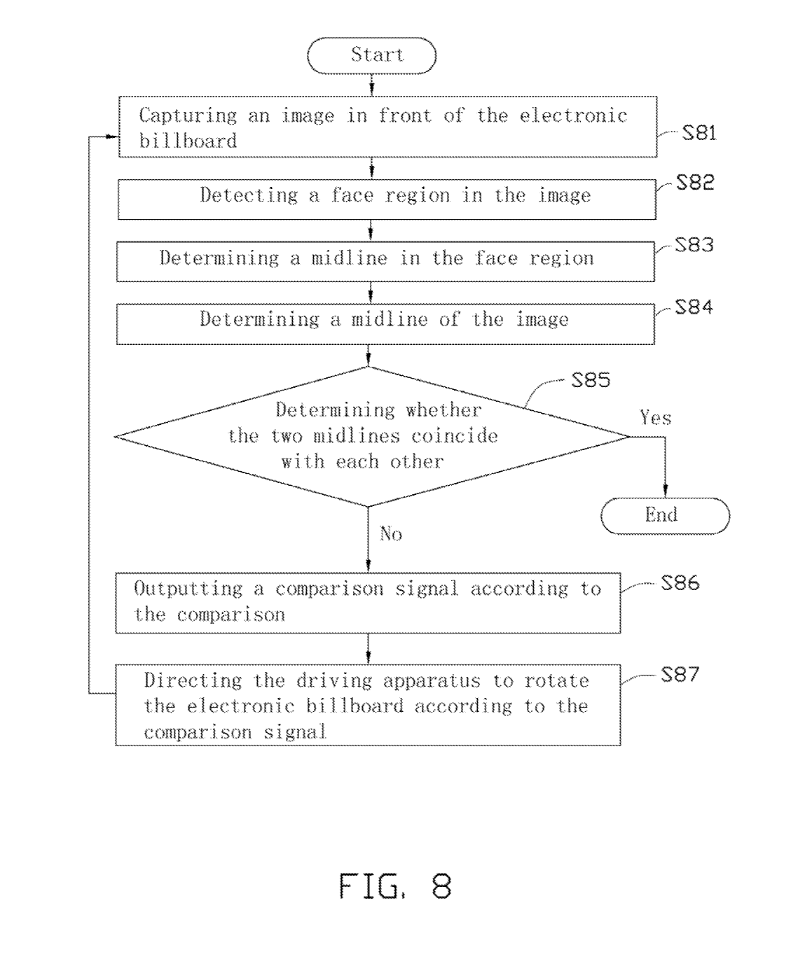

FIG. 8 shows an adjustment method for an electronic billboard 10, the adjustment method includes the following steps.

In step S81, the camera 12 captures an image 30 in front of the electronic billboard 10.

In step S82, the facial detection module 150 detects a face region 32 in the image 30.

In step S83, the first midline determination module 152 determines a midline E1 in the face region 32.

In step S84, the second midline determination module 153 determines the midline M1 of the image 30.

In step S85, the comparison module 156 compares the midline E1 of the face region 32 with the midline M1 of the image 30 to determine whether the midline E1 and the midline M1 coincide with each other. Once the midline E1 and the midline M1 coincide with each other, the viewer can comfortably view the contents on the electronic billboard 10 and the process ends. If the midline E1 and the midline M1 do not coincide with each other, step S86 is implemented.

In step S86, the comparison module 156 outputs a comparison signal according to the comparison.

In step S87, the control module 158 directs the driving apparatus 16 to rotate the electronic billboard 10 according to the comparison signal, and step S81 is repeated.

The foregoing description of the embodiments of the disclosure has been presented only for the purposes of illustration and description and is not intended to be exhaustive or to limit the disclosure to the precise forms disclosed. Many modifications and variations are possible in light of the above disclosure. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A media display system, comprising:
an electronic billboard rotatably attached to a bracket;
a camera mounted on a midline of the electronic billboard, to capture an image of a viewer;
a driving apparatus to adjust an angle of the electronic billboard relative to the bracket;
a processing unit; and
a storage unit connected to the processing unit, the camera, and the driving apparatus, and storing a plurality of programs to be executed by the processing unit, wherein the storage unit stores:
a facial detecting module to detect a face region in the image;
a first midline determination module to obtain a midline of the face region in the image;
a second midline determination module to obtain a midline of the image;
a comparison module to compare the midline of the face region with the midline of the image and determine whether the midline of the face region and the midline of the image coincide with each other, and output a comparison signal correspondingly; and
a control module to control the driving apparatus to rotate the billboard according to the comparison signal.

2. The media display system of claim 1, wherein the driving apparatus comprises a motor attached to a top of the bracket and at least one rotating block attached to a rear side of the billboard, an axis of the motor is engaged in one of the at least one rotating block.

3. The media display system of claim 1, wherein the control module directs the driving apparatus to rotate the billboard through a clockwise angle in response to the midline of the face region being lower than the midline of the image.

4. The media display system of claim 1, wherein the control module directs the driving apparatus to rotate the billboard through an anti-clock angle in response to the midline of the face region being higher than the midline of the image.

5. A media display system, comprising:
a bracket;
an electronic billboard rotatably attached to the bracket;
a camera mounted on a midline of the electronic billboard, to capture an image in front of the electronic billboard;
a driving apparatus to adjust an angle of the electronic billboard relative to the bracket;
a processing unit; and
a storage unit connected to the processing unit, the camera, and the driving apparatus, and storing a plurality of programs to be executed by the processing unit, wherein the storage unit stores:
a facial detecting module to detect face regions in the image;
a first midline determination module to obtain midlines of the face regions in the image, and obtain an average midline of the midlines;
a second midline determination module to obtain a midline of the image;
a comparison module to compare the average midline with the midline of the image to determine whether the average midline and the midline of the image coincide with each other, and output a comparison signal correspondingly; and
a control module to control the driving apparatus to rotate the billboard according to the comparison signal.

6. The media display system of claim 5, wherein the driving apparatus comprises a motor attached to a top of the bracket and a rotating block attached to a rear side of the billboard, an axis of the motor is engaged in the rotating block.

7. The media display system of claim 5, wherein the control module directs the driving apparatus to rotate the billboard through a clockwise angle in response to the average midline being lower than the midline of the image.

8. The media display system of claim 5, wherein the control module directs the driving apparatus to rotate the billboard through an anti-clockwise angle in response to the average midline being higher than the midline of the image.

9. An adjustment method for a media display system, the adjustment method comprising:
capturing an image in front of a billboard of the media display system by a camera;
detecting a face region in the image;
obtaining a midline of the face region;
obtaining a midline of the image;
comparing the midline of the face region with the midline of the image to determine whether the midline of the face region and the midline of the image coincide with each other, and outputting a comparison signal in response to the midline of the face region and the midline of the image not coinciding with each other; and
directing a driving apparatus to rotate the billboard according to the comparison signal to adjust an angle of the billboard.

10. The adjustment method of claim 9, wherein the control module directs the driving apparatus to rotate the billboard through a clockwise angle in response to the midline of the face region being lower than the midline of the image.

11. The adjustment method of claim 9, wherein the control module directs the driving apparatus to rotate the billboard through an anti-clockwise angle in response to the midline of the face region being higher than the midline of the image.
